(19) United States
(12) Patent Application Publication
(10) Pub. No.: US 2022/0028005 A1
(43) Pub. Date: Jan. 27, 2022

(54) MUTUAL INSURANCE DECENTRALIZED AUTONOMOUS FUNDS

(71) Applicant: Viet Le, Hingham, MA (US)

(72) Inventor: Viet Le, Hingham, MA (US)

(21) Appl. No.: 16/938,262

(22) Filed: Jul. 24, 2020

(51) Int. Cl. G06Q 40/08; G06Q 40/06; G06Q 10/10; G06Q 30/02; G06Q 50/18; G06F 16/27

(52) U.S. Cl. CPC G06Q 40/08; G06Q 40/06; G06Q 10/10; G06Q 2230/00; G06Q 50/18; G06F 16/27; G06Q 30/0213

(57) ABSTRACT

The present invention comprises a method of creating and organizing a Mutual Insurance Decentralized Autonomous Fund, which is a mutual insurance fund sitting on top of a decentralized autonomous organization, using smart contracts of blockchain technology. The combination between a mutual insurance fund and a decentralized autonomous organization opens up a great chance for policyholders, being also shareholders of the fund, to save their insurance costs. A Selective Groupon Sale is a method to create conditional groupon deals aiming at gathering a group of low-risk policyholders, for example a group of drivers having 5 consecutive years without any claims or accidents, into a DAF to make it a much lower risk insurance fund. Applying these methods together helps lower some of the highest entry barriers for new companies to participate into the insurance market, and so create more competition and help save costs for policyholders altogether.

### FIELD OF THE INVENTION

The present invention relates to a novel mutual insurance fund. More particularly, the invention relates to a method for creating and organizing a mutual insurance fund as a decentralized autonomous organization, using blockchain technology and smart contracts. I name it Mutual Insurance Decentralized Autonomous Fund, or in short DAF.

### BACKGROUND

While insurance giants have so much power to increase the price, if policyholders file claims, the policyholders just have a very little chance to save a penny, even they haven't made any claims for years.

Insurance is one of the industries with the highest entry barriers akin to banking. Firstly it requires a large number of participants to share risks and make insurance operations effective. The other entry barrier is that it requires a large reserve collateral fund which is so hard for small businesses to enter.

Therefore, a need exists in the industry to have more competitive and cheaper insurance products.

### BRIEF SUMMARY OF THE INVENTION

The present invention comprises methods for creating Mutual Insurance Decentralized Autonomous Fund, Selective Groupon Sale and Decentralized Claim-Processing Workflow to allow small businesses overcome two of the most difficult obstacles to enter the insurance market: (1) mitigate the requirement of a huge reserve collateral fund for insurance operation and (2) to quickly reach a large number of policyholders participating in their insurance programs to make them effective in terms of risk dilution and sharing. The final result is to provide more competition in the insurance market and bring more cost savings to insurance policyholders.

### BRIEF DESCRIPTION OF THE DRAWINGS

Some embodiments of the present invention are illustrated as examples and are not limited by the figures of the accompanying drawings, in which like references may indicate similar elements and in which:

FIG. 1—FIG. 1 depicts the workflow of one example of forming, managing and operating a DAF.

FIG. 1—Participants in FIG. 1 depict buyers of insurance groupon sale deals. The Participants will be transformed and become the insurance policyholders whenever the deals succeed and the required legal documents by laws are fulfilled in order to add them to a DAF

FIG. 1—Groupon Contract in FIG. 1 shows one example of a groupon sale deal using a smart contract to help enroll Participants and turn them into members of the DAF if the deal gets enough number of Participants.

FIG. 1—DAO Contract in FIG. 1 shows one example of using a smart contract to help organize the mutual insurance fund for the Participants, who have now become policyholders, including but not limited to functions such as policyholders' voting, history verification, and claim payouts.

FIG. 1—Claim Contract, Auditor Contract and Oversight Board Contract in FIG. 1 show one example of using smart contracts to help operating decentralized claim-processing activities underneath the DAF.

FIG. 1—Claim-Processing Contractor in FIG. 1 depicts individuals or business entities who are contracted by the DAF to participate into the claim-processing operation, including but not limited to, receiving claims, contacting claimants, deny or pre-approve and escalate claims for final approval.

FIG. 1—Contracting Auditors in FIG. 1 depict individuals or business entities who are contracted by the DAF to participate into the decentralized claim-processing operation, including but not limited to, audit the works of the Claim-Processing Contractors, investigate claims returned by a Oversight Board.

FIG. 1—Oversight Board Members in FIG. 1 depicts individuals who are voted by the DAF policyholders, who are also at the same time owners of the DAF, in a DAF oversight board election, to participate into the claim-processing operation, including but not limited to, approve or return claims for further investigation and other mutual fund management works.

FIG. 1—Blockchain in FIG. 1 shows one example of using blockchain technology, both public or private, for implementation of the above-mentioned smart contracts, including but not limited, ethereum blockchain, hyperledger blockchains.

FIG. 1—External DB in FIG. 1 shows one example of using the database outside the blockchain to store policyholder's sensitive private information, which is not suitable to be stored plainly on the blockchain.

### DETAIL DESCRIPTION OF THE INVENTION

The terminology used herein is for the purpose of describing particular embodies only and is not intended to be the limiting of the invention. As used herein, the term “and/or” includes any and all combinations of one or more of the associated items. As used herein a singular form “a”, “an” and “the” are intended to include plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical, scientific and business terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of relevant the art and the present disclosure and will not be interpreted in an idealized or overly formal sense unless expressly so define herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A method to create a Mutual Insurance Decentralized Autonomous Fund is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

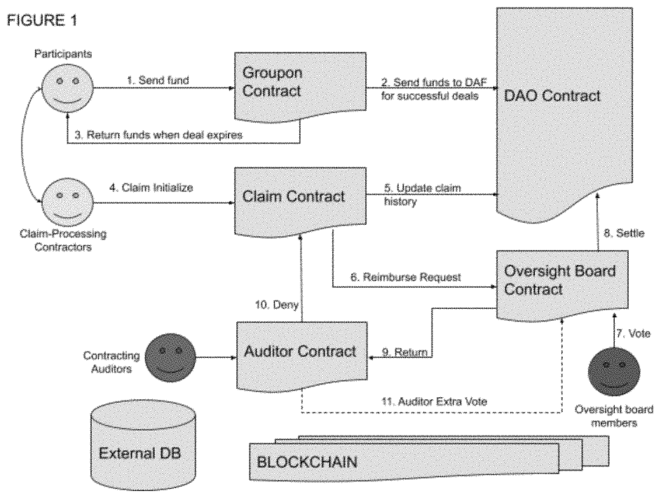

The present invention will now be described by referencing the appended figure representing preferred embodiments. FIG. 1 depicts a diagram of the elements that may comprise a Mutual Insurance Decentralized Autonomous Fund operations according to various embodiments of the present invention. In preferred embodiments, each of the elements having a name ending with “Contract” are implemented in a single smart contract or in a few separated smart contracts. Similarly, a group of these elements having a name ending with “Contract”, or all of them, can also be implemented in a single smart contract or in many separated smart contracts.

A mutual insurance fund is an insurance company that is owned by policyholders. The sole purpose of a mutual insurance company is to provide insurance coverage for its members and policyholders, and its members are given the right to select management.

A smart contract in this context refers to a self-executing contract with the terms of the agreement between a taker (for example a buyer) and a maker (for example a seller) being directly written into lines of code. The code and the agreements contained therein exist across a distributed, decentralized blockchain network. The code controls the execution, and outcome transactions are trackable and irreversible. Smart contracts permit trusted transactions and agreements to be carried out among disparate, anonymous parties without the need for a central authority, legal system, or external enforcement mechanism.

Recently, the development of blockchain technology and smart contracts has allowed a new type of organization, Decentralized Autonomous Organization—DAO, sometimes labeled as Decentralized Autonomous Corporation—DAC to exist. This is an organization represented by rules encoded as a computer program that is transparent, controlled by shareholders and not influenced by a central government. A DAO's financial transaction record and program rules are maintained on a blockchain.

The present invention comprises a method for creating and organizing a Mutual Insurance Fund as a Decentralized Autonomous Organization, so called a Mutual Insurance Decentralized Autonomous Fund or DAF. Until now, setting up and organizing a mutual fund is a complex process and requires a lot of centralized efforts from the creators of the fund. The first step of the present invention is to create a DAO smart contract that allows policyholders to pool their money, and to vote among themselves an oversight board to manage the pool. The combination of a mutual insurance fund with DAO smart contract makes it possible to create a mutual insurance fund in a decentralized manner, without or with just insignificant centralized efforts. And so it opens up an opportunity for having a lot more competitions in the insurance market. This is an important step, because until now, in most of the cases, money paid to the insurance companies by policyholders, to buy insurance policies, belongs to these insurance companies. The insurance companies tend to maximize their profit, and so they normally don't lower their price significantly even in case a policyholder hasn't made any claims for years. With a DAF, policyholders are the owners of the fund. So there is a much greater chance that the policyholders would lower the price for themselves.

The biggest obstacle of running a DAF [0026] is a big reserve collateral fund needed for insurance operations. Until there are a large enough number of policyholders participating in an insurance program so as risks are well diluted and shared. It depends almost completely on an insurance company's capital to cover accidents if they happen here and there. Because of that, until now, it is so hard for small companies, without a huge capital reserve, to enter the insurance market. These companies will not be able to protect themselves from a sudden bankruptcy, with a certain level of confidence because their tiny capital would be most probably quickly drained out before they reach a certain number of participants.

In recent years, the creation of a groupon sale method has allowed a large number of clients to have deals on goods and services. The group-on sale works as an assurance contract: if a certain number of people sign up for the offer, then the deal becomes available to all. If the predetermined minimum is not met, no one gets the deal.

The present invention further comprises a new method for groupon sale, named a Selective Groupon Sale method, in which not everyone, but just selective people with, to a certain extent, lower risk of causing accidents, for example a group of drivers having 5 consecutive years without any claims or accidents, are allowed to participate in a Selective Groupon Sale. The important characteristic of a Selective Groupon Sale is that its conditions may be verified by its smart contract [0024].

The second step of a method for creating and organizing a Mutual Insurance Fund as a Decentralized Autonomous Organization [0026] is to create an offer of a traditional groupon sale, or a Selective Groupon Sale as described in [0029], with a certain size of the groupon deal, whichever is deemed effective, for policyholders to participate in the DAF, for example a groupon deal of 50,000 policyholders. The purpose of this step is to mitigate the obstacle as described in [0027]. If a groupon deal becomes available, then immediately a DAF has enough number of policyholders participating in its insurance program to make an effective insurance operation. In the example above, let's assume the average price is $600 per policyholder, then the DAF will be a 30 million dollar fund with 50,000 policyholders from day 1. If Selective Groupon Sale are used throughout the life of a DAF, the fund value will be reasonably forecasted to get bigger and bigger considering its recruiting of just low-risk policyholders. In the above example, let's make an extreme assumption. Say the second year average price is reduced to $500 per policyholder and no claims are filed in the first year, then the DAF will add 25 million dollars to the DAF. Let's assume further that the overhead and operation costs can be managed to be insignificant in comparison with the total funds. Then the DAF will be almost 55 million dollars after just 2 years, so on and so forth. This second step helps significantly mitigate the reserve collateral requirement that is a huge entry barrier for small companies to provide insurance coverage in a market.

The present invention further comprises a third optional step to create a decentralized claim-processing workflow based on a smart contract to assist a DAF. The essential parts of the decentralized claim-processing workflow include the claim-processing contractors, contracting auditors and DAF oversight board. These parts create and maintain a check and balance mechanism to ensure the transparent operations of the DAF to its shareholders. Such smart contracts save the essential claim history of policyholders to a public storage on the blockchain, so as conditions of Selective Groupon Sale can be verified.

Although the present invention has been illustrated and described herein with reference to preferred embodiments and specific examples thereof, it will be readily apparent to those of ordinary skill in the art that other embodiments and examples may perform similar functions and/or archive like results. All such equivalent embodiments and examples are within the spirit and scope of the present invention, are contemplated thereby, and are intended to be covered by the following claims.

What is claimed is:

1. A method for creating and managing a Mutual Insurance Decentralized Autonomous Fund (DAF), comprising of:
step 1: creating a DAO smart contract that allows policyholders to pool their money, and to vote among themselves an oversight board to manage the money;
step 2: creating an offer of a groupon sale for a large number of the policyholders to participate in the DAF from its first day.

2. The method of claim 1 further comprising of an alternative of step 2 by using a Selective Groupon Sale method, comprising of:
a. creating a sale condition what can be verified by smart contracts;
b. creating a groupon sale smart contract with the conditions in step 1.

3. The method of claim 1 further comprising of step 3 to create a Decentralized Claim-Processing Workflow to assist a DAF, comprising of:
a. creating at least one Claim Contract (smart contract) for claim-processing contractors to interact with DAO smart contract of a DAF and the related smart contracts in this method;
b. creating at least one Auditor Contract (smart contract) for contracting auditors to interact with DAO smart contract of a DAF and the related smart contracts in this method;
c. creating at least one Oversight Board Contract (smart contract) for oversight board members to interact with a DAO smart contract of a DAF and the related smart contracts in this method.
